(19) United States
(12) Patent Application Publication
(10) Pub. No.: US 2003/0163348 A1
(43) Pub. Date: Aug. 28, 2003

(54) Method and system for clinical action support

(76) Inventors: William W. Stead, Nashville, TN (US); Randolph A. Miller, Brentwod, TN (US); Antoine Geissbuhler, Veyrier (CH); Karen Hughart, Nashville, TN (US); Jonathan Grande, Nashville, TN (US); Randy Bates, Franklin, TN (US); Douglas Talbert, Cookeville, TN (US); Jeff Byrd, Mt. Juliet, TN (US); John M. Starmer, Minneapolis, MN (US); Nikolay Silkin, Nashville, TN (US)

Correspondence Address: ATTN: Patent Group, COOLEY GODWARD LLP, One Freedom Square, Reston Town Center, 11951 Freedom Drive, Reston, VA, 20190-5601, US

(21) Appl. No.: 10/083,649

(22) Filed: Feb. 27, 2002

(51) Int. Cl. G06F 17/60

(52) U.S. Cl. 705/2

(57) ABSTRACT

A method and system for clinical order entry and decision support are provided. The system and method allow physicians to input orders directly in clinical shorthand. The system presents high-probability choices for order action, determination of clinical context and possible problem solutions. The choices reflect current medical research, patient-specific information and standard practices of other physicians and/or administrators. Selections or edits to the presented choices can be entered quickly and easily, thereby allowing automated generation of complete orders needed to carry out the decisions made. In this way, medical decisions can be made and executed in a fast, efficient and standardized manner.

### STATEMENT OF GOVERNMENT SUPPORT

This invention was made with government support under Grant Nos. 5G08 LM05443, R01 LM06226, and R01 LM06920 awarded by the National Library of Medicine. The US Government has certain rights in the invention as a result of this support.

### BACKGROUND OF THE INVENTION

1. Field of the Invention

The present invention relates to a method and system for assisting a user in making medical decisions and translating those decisions into action. More specifically, the present invention relates to a system for allowing a user, such as a physician, to quickly, accurately and safely perform his or her duties.

2. Description of the Related Art

In the medical field, physicians must diagnose and treat a disease or injury of a particular patient quickly and accurately. Making a particular diagnosis or treating the disease/injury may be difficult or impossible if the physician does not have access to the most current pertinent information. This, coupled with the fact that diagnoses and treatments are constantly being updated and expanded, makes it difficult for physicians to keep abreast of these developments in the practice of medicine.

Similarly, tests for screening for problems or exploring probable diagnoses, as well as appropriate procedures to be performed or medications to be prescribed once the diagnosis is made, are frequently updated and/or improved. Thus, it is also difficult for physicians to possess current knowledge regarding new testing or treatment procedures and medications.

Additionally, physicians frequently issue orders to be carried out by other parties, so as to most efficiently use the physician's time and to bring others' skills or technologies to bear. For example, a physician making rounds in a hospital, during the course of any given day, writes many prescriptions for various medications, orders various testing procedures such as blood or urine analyses, etc. Various safety factors must be considered in issuing and implementing these orders. For example, many drugs have adverse reactions in a patient when used together by that patient. Additionally, the patient may be allergic to certain drugs or classes of drugs.

Moreover, even if the above factors are taken into account, the prescription or other order must be forwarded accurately to the other medical personnel, so as to service the patient accurately and safely. Also, the forwarded information must take into account different terminology for the same clinical action that is sometimes used by different personnel/departments within a hospital. Moreover, the need for maintaining accuracy and reducing error is especially important when considering the volume of orders issued by a physician in a given day and the potential liability to the physician for an erroneous decision.

Because physicians typically make the types of decisions referred to above on an individual basis (or within a small group of physicians), there is often non-trivial variation in the diagnosis and treatment of patients presenting similar symptoms in different cities, hospitals, or even departments within a single hospital. This variation in practice may lead to various inefficiencies and other undesirable results, including reduced profit margins and excessive use of certain medications/tests (or, conversely, insufficient use of needed medications/tests). For example, if an equally effective generic version of a drug for a given disease becomes available, or if a new drug becomes available that is more effective and/or less expensive than a conventionally-used drug, then costs associated with treating that disease can be decreased and/or treatment for that disease can be improved.

A final difficulty faced by physicians with respect to making and executing medical decisions is the difficulty in complying with the billing requirements put upon them by their respective hospital, HMO or other health care management system. Such billing requirements can be detailed and administratively arduous, and are often outside the expertise (and patience) of the physicians.

Conventionally, physicians may note their decisions in a chart in clinical shorthand, so that some other health professional, such as a unit clerk, may translate the orders into administrative orders and requisitions needed to get them carried out. This translation requires, for example, expansion of abbreviations, conversion of the clinical name of the orderable into the administrative name in use in the facility, and completion of additional detail needed to perform the order.

This conventional paradigm for executing a physician's orders has many inefficiencies, and does not solve any of the problems discussed above. For example, this system is subject to errors in the unit clerk reading the doctor's handwriting, does not provide the physician with any additional information regarding the decision/order, and does not reduce variations in practice between physicians.

Conventional systems for order entry by the physician exist which allow the physician to directly enter the order via a computer terminal. Although such systems have the ability to alleviate some of the above problems by providing information to the physician via a database, obtaining legible orders and checking for errors, such systems essentially require the doctor to enter an administrative order or requisition directly. Thus, the physician is asked to perform the administrative work of the unit clerk (e.g., translating the orders from clinical shorthand to plain English and filling in the administrative details needed to carry out the order). As a result, such conventional physician order entry systems are difficult to implement because they waste physician time. Moreover, such systems may introduce a new source of error as physicians deal with administrative details that are not within their clinical areas of expertise. Since such systems are reactive to physician-initiated action, their effect on variability of practice is minimal.

Therefore, what is needed is a method and system for assisting a physician in performing his or her duties, that solves the problems discussed above while fitting naturally into physician workflow. A fundamentally new interaction of people, process and technology is required to achieve this goal.

### SUMMARY OF THE INVENTION

The present invention relates to a method and system for providing a physician or other caretaker with clinical action support.

In one embodiment, the present invention proactively determines the clinical context (i.e., identifies the problem being handled). This context is used as the basis for presenting information about best practices for that situation, tailored to information about the specific patient. Selections or edits can be noted quickly, thereby allowing automated generation of the complete orders to carry out the decisions.

According to a first exemplary embodiment, the present invention relates to a method for supporting a clinical action to be ordered by a clinician. Such a method may include receiving a request for an order from the clinician and thereafter making a determination as to a clinical context of the order. The method may also include presenting practice information to the clinician, based on the clinical context. The practice information may serve to describe a pre-determined practice method for executing the clinical action. Finally, the method may include generating an order for the clinical action, based on input from the clinician with respect to the practice information.

According to a second exemplary embodiment, the present invention relates to a system for receiving order information from a clinician and generating an order based thereon. Such a system may include at least two parts, an order-entry subsystem and a best-practice subsystem. The order-entry subsystem may serve to receive an order request from the clinician. The best-practice subsystem may serve to determine a clinical context for the order and provide pre-determined practice information for enacting the order, based on the clinical context.

According to a third exemplary embodiment, the present invention relates to an article of manufacture having a computer-readable medium, the computer-readable medium having stored therein a computer program carrying out a method for generating medical orders. Such a computer program may include a plurality of code segments having various functionalities. For example, the computer program might include a first code segment for presenting high-probability action choices to a clinician based on an order request entered by the clinician. A second code segment might be included for presenting high-probability clinical context choices to the clinician, based on an action chosen by the clinician. The computer program might also include a third code segment for presenting practice methods based on a clinical context chosen by the clinician. Finally, a fourth code segment might be included for generating the medical order based on a practice method chosen by the clinician.

The features and advantages of the invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 demonstrates a block diagram of an exemplary embodiment of the present invention.

FIG. 2 demonstrates a work flow of an embodiment of the present invention.

FIG. 3 is an example of a first screen view according to one embodiment of the present invention.

FIG. 4 is an example of a second screen view according to one embodiment of the present invention.

FIG. 5 is an example of a third screen view according to one embodiment of the present invention.

### DETAILED DESCRIPTION

While the present invention is described below with respect to various exemplary embodiments, the present invention is not limited to only those embodiments that are disclosed. Other embodiments can be implemented by those skilled in the art without departing from the spirit and scope of the present invention.

Various embodiments of the present invention seek to solve the problems discussed above and provide a physician with a means for quickly, accurately and easily fulfilling his or her duties. Although physicians are primarily discussed herein as the users of the present invention, any other member of the care team such as a nurse, physical therapist, physician's assistant, receptionist, etc., may utilize the present invention to the extent authorized by such a user's levels of knowledge, experience and licensure.

Facilitation of the use of best practice or practices is achieved by virtue of the present invention. Best practices, as is discussed in more detail below, generally refer to a standardization of diagnoses and treatments decided upon by physicians, while taking into account individual attributes and needs of particular patients. Such standardization permits an increase in the quality of health care administered, while simultaneously increasing physician efficiency and reducing cost to the patient and/or health care provider.

Various embodiments of the present invention provide a physician with patient data and needs in conjunction with local and national protocols. This information is provided at a time and place that facilitates the physician in making the pertinent medical decision(s). This information may include all orders related to a patient's visit together with relevant findings, giving the physician a single source from which to obtain information about that patient and their diagnosis and/or treatment.

Various aspects of the present invention serve as a tutor that provides the physician with suggestions and instructions regarding possible changes in the physician's practice that may benefit the patient at hand. Other aspects of the present invention serve as a personal unit clerk to the physician by translating his or her clinical decision(s), entered directly in clinical shorthand, into administrative orders to be carried out, thereby eliminating the need for the physician to be aware of, or knowledgeable about, the associated administrative practices and procedures. Finally, the present invention serves as an aid in vigilantly checking for potential errors and diligently providing documentation for billing compliance.

By way of the above-listed features, the present invention reduces variability in physician practice, expedites the introduction of new research findings and other information into that practice, generates billing compliant documentation, and reduces errors that might otherwise occur. Thus, unneeded procedures, tests and drugs are administered less often, and the efficiency and quality of administered health care is improved.

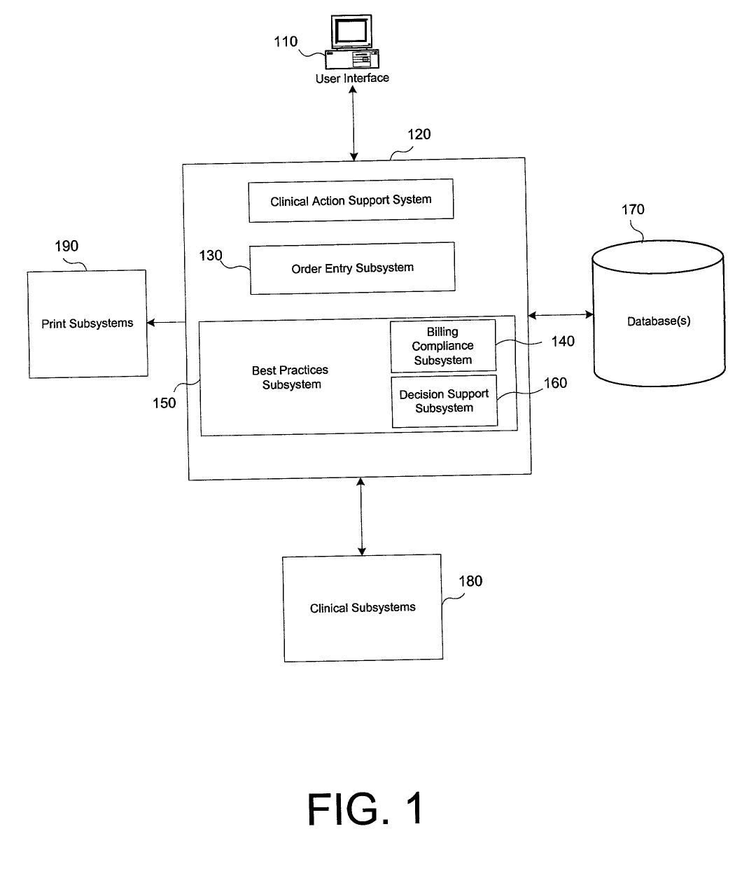

FIG. 1 demonstrates a block diagram of an exemplary embodiment 100 of the present invention. In FIG. 1, a user such as a physician or other clinician having authorization accesses a Clinical Action Support System (CASS) 120 through a user interface 110. CASS 120 includes an order entry subsystem 130, a decision support sub system 140, a best practices subsystem 150 and a billing compliance subsystem 160. CASS 120 interacts with one or more databases represented by database 170, and may output orders or other information to clinical subsystems 180 and/or print subsystem 190.

Order entry subsystem 130, in broad terms, assists the physician in entering an order to be implemented by some other clinician or administrative personnel. These orders specify everything to be done for the patient, ranging from prescriptions for medication and requests for diagnostic testing and/or other medical procedures to diet and allowed activities. As is discussed in more detail below, order entry subsystem allows the physician to enter orders directly in clinical shorthand, and does not require the physician to convert the orders into plain English and/or add administrative detail.

Best practices subsystem 150 generally assists the physician in deciding between multiple courses of action in a manner that standardizes practice and procedure between multiple physicians and/or multiple health care facilities. Best practices subsystem 150 first receives an entered order and then assists in determining the nature of the problem (illness or injury) that is at issue and/or the clinical context of the problem.

Clinical context refers to a setting for a particular order, for example, why the order is necessary, what contraindications exist (including allergies and other individual contraindications), what related orders may be necessary, related orders that may already have been processed and their status and additional information that may be necessary/helpful in making final order decisions.

Once determined, the clinical context serves as a basis for presenting the physician with treatment options that are tailored to the patient being treated. In this way, the physician can make selections quickly and easily, and complete orders can be automatically generated and sent to print subsystems 190 and/or clinical subsystems 180.

For example, a given diagnostic test may be utilized by one physician but not another in a given situation. As another example, a brand medication and its generic counterpart may each treat a particular disease equally well, but the generic version may be considerably cheaper. Best practices subsystem 150 may set forth the preference(s) of a given hospital or other health care employer for dealing with such situations. More detailed examples of the operation of best practices subsystem 150 are discussed below.

By proactively setting the clinical context for the physician based on a clinical shorthand order the physician is entering, best practices subsystem 150 enables fast, efficient, standardized techniques for diagnosing and treating patients, while still taking into account the individual needs of particular patients.

Decision support subsystem 140 within best practices subsystem 150 assists in enabling best practice methods by providing the physician with, for example, clinical rules, real-time knowledge links to sources of current medical research or protocols, specific patient information such as allergies, drug interactions, etc.

Billing compliance subsystem 160 ensures that the physician complies with all billing requirements of the payor. For example, a given intermediary may require one of a list of possible reasons motivating the use of a certain procedure such as a chest X-ray. However, a given physician may often simply order the chest X-ray and not provide the reason(s) why it was ordered. In one embodiment, the present invention guards against this possibility by using the clinical context to guide physicians toward orders that are justified by the problems that make up that context, and by requiring the motivating reasons if an order that the context does not justify is entered. Thus, billing compliance subsystem 160 operates to output billing documentation in conformance payor-specific internal procedures and practices.

It should be understood that the present invention need not simply present the physician with a large, hierarchical decision tree for making decisions and/or entering orders. Various forms of conventional systems take such an approach; however, such systems invariably grow into very large decision trees that require excessive input from the physician to reach a desired point on the decision tree and/or to generate an order. Moreover, such systems generally have no knowledge of a clinical context of an order being entered. Therefore, they do not provide the physician with sufficient (or any) information that supports an optimal decision that is endorsed by other physicians and/or administrators, supported by current research and tailored to the needs of the individual patient.

The embodiments of the present invention discussed below, in contrast, present the physician with high-probability choices for an action to be taken. If necessary, the present invention is also capable of presenting high-probability choices for establishing a clinical context and presenting choices for problem solution, based on general and patient-specific information presented to the physician concurrently with the choices. In this way, the physician can quickly and easily enter selections and/or edits, thereby allowing automatic generation of a complete clinical order.

Database(s) 170 may include various types of data. For example, database 170 may include information with respect to a plurality of patients such as problems and procedure, findings and test results, drug allergies, treatment histories, etc. Database 170 may also contain a listing of known clinical rules, drug interactions and so on. Clinical subsystems 180 refer to systems within various departments such as radiology, pharmacy, laboratory, etc. These departments can therefore receive orders from CASS 120 for onsite implementation. Finally, print subsystem 190 refers to a print or other server which serves to route and guarantee output of results of the orders entered/decisions made by a physician using CASS 120.

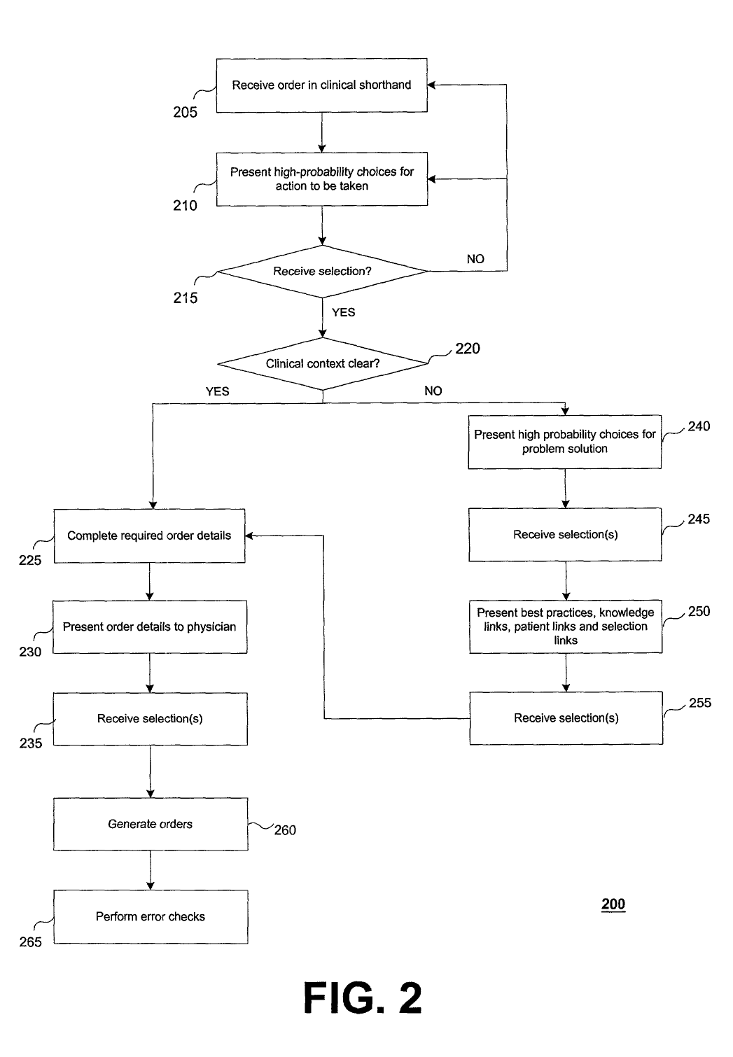

FIG. 2 demonstrates a work flow 200 of an embodiment of the present invention. In operation 205, CASS 120 receives an order entered by a physician in clinical shorthand. In operation 210, CASS 120 predicts options that the physician may need in order to proceed with the order and subsequent clinical actions, and presents high-probability choices from which the physician may choose. CASS 120 then receives a selection made by the physician from amongst the presented choices in operation 215. If no selection is appropriate, the physician may so indicate, whereupon CASS 120 can present other choices and/or receive a different order.

If CASS 120 receives a selection in operation 215, a determination is made in operation 220 as to whether the clinical context of the order is clear. If clinical context is clear for a particular order, then CASS 120 completes required order details in operation 225, presents the order details to the physician in operation 230 and receives selections from the physician in operation 235.

Note that operations 205-235 mimic a normal physician workflow, and avoid the need for presenting a number of menus (and accepting a number of entries) that conventional hierarchical decision-tree type order entry systems require.

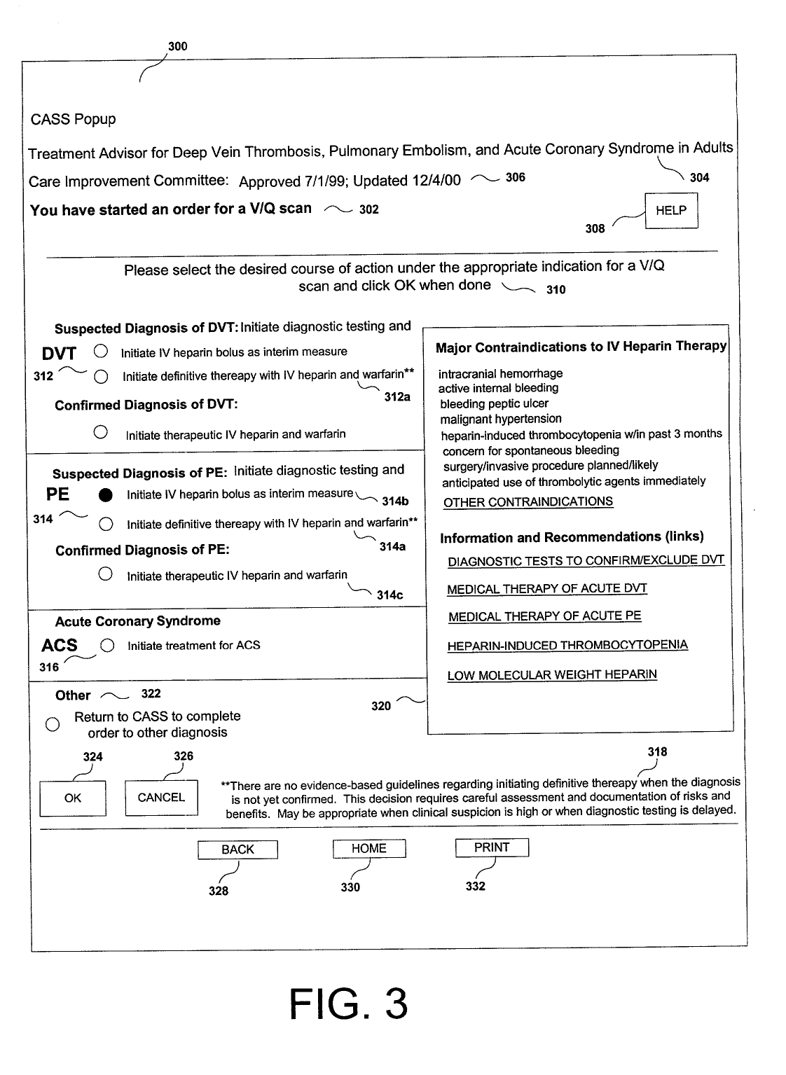

If the clinical context is not clear, so that the system does not have enough information to continue processing the order, then CASS 120 will predict and present problems the physician may be attempting to solve, along with high-probability choices for the solution(s), in operation 240. Operation 240 is discussed in more detail with respect to FIG. 3.

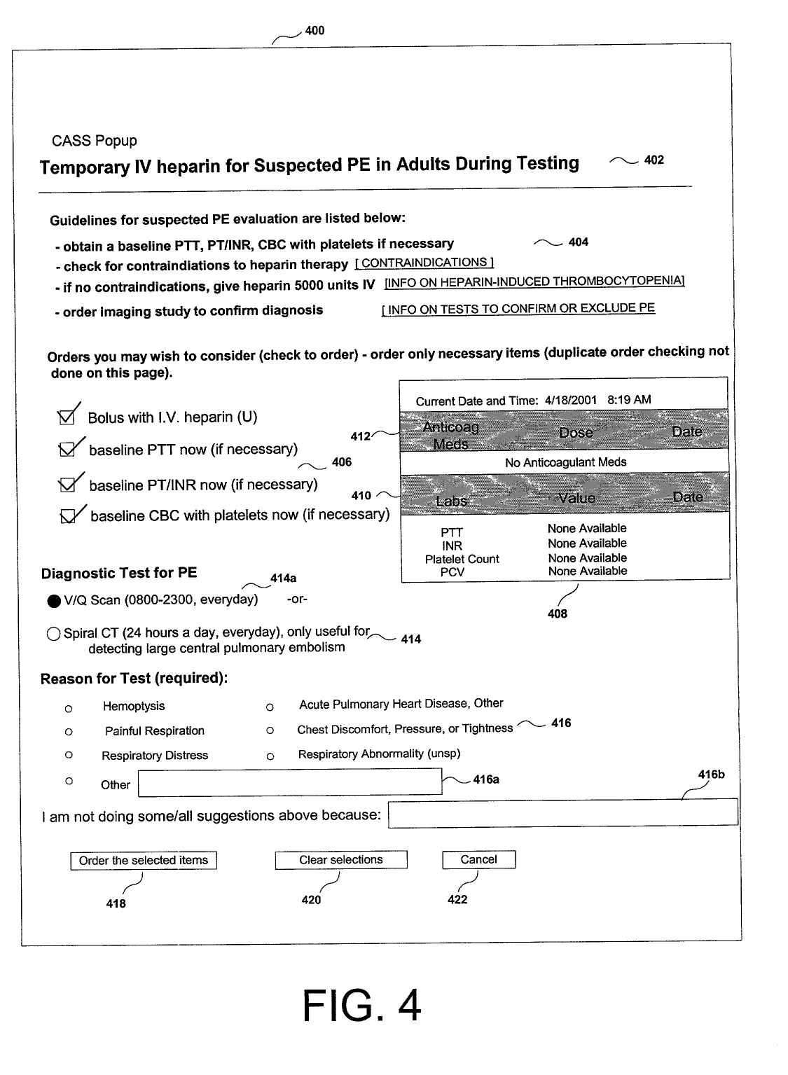

CASS 120 receives selections made by the physician in operation 245, whereupon the system may present best practice methods for implementing the solution(s) together with links to relevant patient, disease, injury and/or medication data. Based on this best practices information, the physician selects an appropriate course of action for completing the order by, for example, clicking on one of the presented choices, so that CASS 120 receives the selection(s) in operation 255. The presentation of best practice information is discussed in more detail with respect to FIG. 4.

Operations 240-255, by establishing a clinical context and thereafter presenting only those choices that are compliant with pre-determined best practice methods, help to eliminate variability in physicians' practices and achieve billing compliance. Additionally, these operations serve to reduce errors and costs associated with patient care. Once operation 255 is complete, the workflow returns to operation 225. From there the workflow continues through operation 235, as described above.

Once CASS 120 has received physician selections in operation 235, the order(s) may be generated in operation 260. Finally, CASS 120 performs an error check in operation 265 before sending the order to the appropriate subsystem for fulfillment.

FIG. 3 is an example of a first screen view according to one embodiment of the present invention that a physician might see when utilizing user interface 110. Specifically, FIG. 3 illustrates a popup screen view 300 presented by CASS 120 to a physician who has begun an order for a V/Q scan (also known as a V/P or ventilation/perfusion test) for a particular patient, as indicated by line 302. As shown by line 304, CASS 120 presents a Treatment Advisor indicating that the order for the V/Q scan reflects a possible diagnosis of either Deep Vein Thrombosis (DVT), a Pulmonary Embolism (PE) or Acute Coronary Syndrome (ACS) in Adults. Line 306 demonstrates to the physician that the information to be provided by screen view 300 has been approved/updated by a committee representing the physician's hospital or other employer and therefore indicating that the information to be presented represents best or recommended practices for the physician to follow. Additionally, Help button 308 provides a link that the physician may follow to obtain additional information with respect to operating CASS 120.

Line 310 requests the physician to establish clinical context by selecting an appropriate indication for the V/Q scan together with the nature of the course of action. Specifically, section 312 allows the physician to indicate a suspected or confirmed diagnosis of DVT, section 314 allows the physician to indicate a suspected or confirmed diagnosis of PE and section 316 allows the physician to indicate a diagnosis of ACS. As shown in lines 312a and 314a, courses of action may include additional information (here, shown by footnote 318) to assist the physician in establishing clinical context.

As shown by the selected (filled) circle in line 314b, the physician in this case has selected a suspected diagnosis of PE as the problem being addressed and indicated a desire to initiate IV heparin bolus as an interim measure. Box 320 provides major contraindications to the selected IV Heparin Therapy, as well as additional information and recommendations. Importantly, as indicated by the underlined text in box 320, the additional information and recommendations are provided as real-time links that the physician may select in order to learn more about the topic in question before making a final decision. As discussed above, these links provide up-to-date research and other information that a physician may not otherwise have access to.

Line 322 presents the physician with the option of returning to a previous screen view in order to complete the order to some other diagnosis if the physician is not satisfied by the choices presented in screen view 300. Finally, buttons 324-332 allow the physician to either approve or cancel the order, move to a previous screen view, return to a home screen view or print the current screen view, respectively.

FIG. 4 represents an example of a next screen view 400 presented to the physician after clicking OK button 324 within screen view 300 according to one embodiment of the present invention. Line 402 indicates that screen view 400 is in fact presented in response to the selection by the physician of a temporary IV heparin for suspected PE in adults during diagnostic testing. Section 404 presents the physician with guidelines for suspected PE evaluation. Again, underlined text represents real-time links the physician may choose to learn more about the presented guidelines.

In section 406, the physician is presented with orders that he or she may wish to consider in conjunction with the selections made so far and the guidelines presented in section 404. Box 408 lists the related information from the patient's record, e.g., orders and their current status, a number of related labs under heading 410 and anticoagulation medication(s) under heading 412 (although in this example no such medications are demonstrated as being currently ordered).

In section 414, the physician is at this point presented with options for actually ordering a diagnostic test for the suspected pulmonary embolism. Here, in line 414a indicated by the shown filled circle, the physician has selected the V/Q scan and an associated timeline for administration of that scan.

In section 416, the physician may enter a reason for the ordered test, and is presented with a number of common reasons to ease in the entry. Of course, if the physician has some other reason he or she may enter it in the text box shown in line 416a. Also, the physician always has the ability to override a given suggestion by the CASS, and may enter reasons for doing so in the text box shown in line 416b. In providing the reason for administering a particular test, it is assured that this aspect of billing compliance is met by the physician.

Finally, the physician may choose to either order selected items, clear current selections or cancel the entire order, using boxes 418-422, respectively.

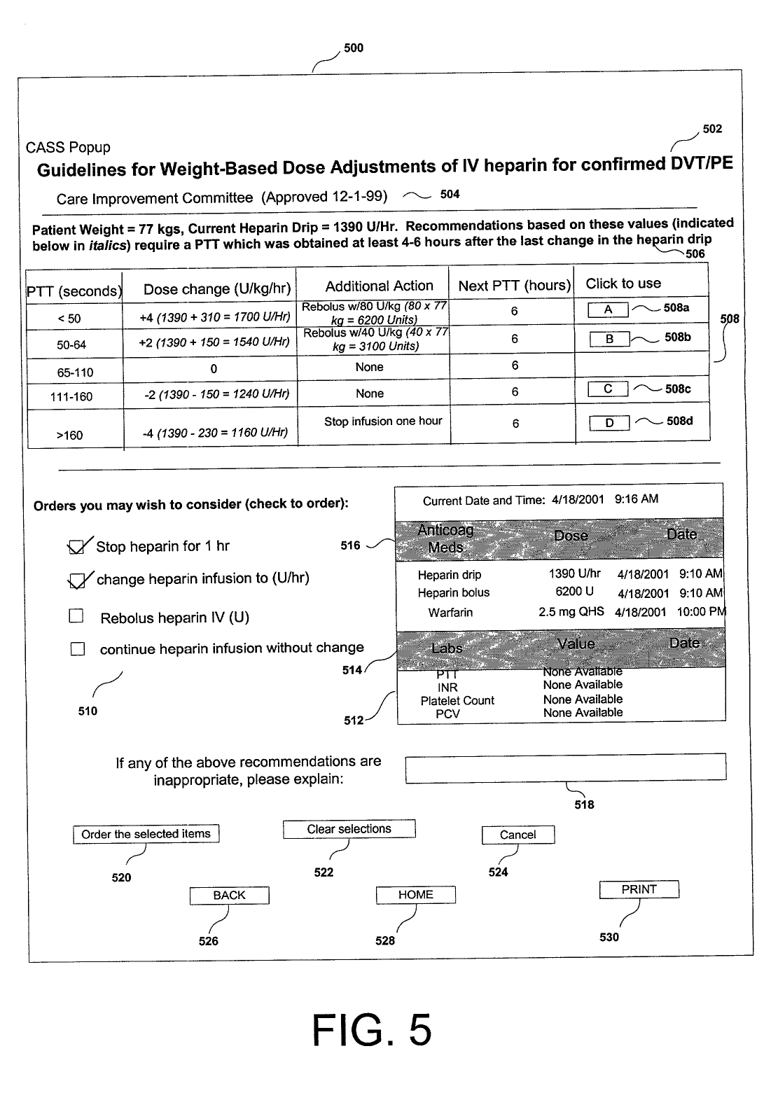

In FIG. 5, an example of a third screen view 500 according to one embodiment of the present invention is shown. Screen view 500 is designed to modify the orders originally generated through screen views 300 and 400 in a manner that takes into account new data showing how the patient is absorbing and metabolizing the administered drugs.

To arrive at FIG. 5, a physician returns to screen view 300 after receiving a positive result from the test(s) administered as a result of completing screen view 400 and clicking button 418. The physician then confirms a diagnosis of PE by selecting button 314c in screen view 300. Accordingly, a heparin infusion is begun and, as is known, is monitored by a technique known as partial thromboplastin time (PTT). In the example shown in screen view 500, the PTT returns high such that the heparin infusion order should be modified.

Thus, as indicated by line 502, screen view 500 presents guidelines for weight-based dose adjustments of IV heparin for a confirmed DVT/PE. Again, line 504 indicates that the recommended guidelines have been approved by the physician's supervisor(s)/employer(s).

In the example of screen view 500, a patient weight of 77 kg is used, which, along with current infusion rate and required test conditions, is shown in line 506. Box 508 demonstrates standard choices that the physician can make in ordering and administering the infusion based upon the PTT results as shown in boxes 508a-d.

In section 510, the physician may choose from among orders, or click on 598a, b, c, or d to request that the system fill in the orders associated with that protocol. Box 512 demonstrates the current status of various orders including labs listed under heading 514 and anticoagulation medications listed under heading 516. As demonstrated in box 512, values of medications actually administered (and labs, not shown) can be displayed virtually in real-time, so that the physician has access to this information to aid in making current and future orders.

Finally, as before, the physician may indicate in the text box shown in line 518 if the provided recommendations are inappropriate. Also as before, the physician may order selected items, clear current selections or cancel the entire order, using boxes 520-524, respectively, or may move to a previous screen, return to a home screen or print the current screen using buttons 526-530, respectively.

In conclusion, the various embodiments of the present invention discussed herein demonstrate a method and system for making medical decisions and easily translating those decisions into action in an efficient and standardized manner. Physicians may enter orders in clinical shorthand, which is an easy and effective method for them to use, and need not later be responsible for translating the orders into English for execution. The present invention does not force the physician to select from a predetermined hierarchical decision tree in order to enter a clinical order, but rather presents the physician with high-probability choices for action to be taken. The present invention is also capable of presenting the physician with high-probability choices for establishing clinical context, and in so doing, provides the physician with decision support that enables and encourages physicians to conform their actions to a set of pre-determined best practices, while still taking into account individual patient needs.

While this invention has been described in various explanatory embodiments, other embodiments and variations can be effected by a person of ordinary skill in the art without departing from the scope of the invention.

What is claimed is:

1. A method for supporting a clinical action to be ordered by a clinician, the method comprising:
receiving a request for an order from the clinician;
determining a clinical context of the order;
presenting practice information to the clinician, based on the clinical context, describing a pre-determined practice method for executing the clinical action; and
generating an order for the clinical action based on input from the clinician with respect to the practice information.

2. The method of claim 1, wherein said receiving a request for an order from the clinician further comprises:
receiving the request for an order in clinical shorthand.

3. The method of claim 1, wherein said generating an order for the clinical action further comprises:
generating a natural-language version of the order with detail required for implementation.

4. The method of claim 1, wherein said determining a clinical context of the order further comprises:
presenting high-probability choices for the clinical context based on the request for the order.

5. The method of claim 1, wherein said presenting practice information to the clinician further comprises:
presenting links to decision-support information

6. The method of claim 1, wherein the practice information includes pertinent current medical research information.

7. The method of claim 1, wherein the practice information includes patient-specific information.

8. A system for receiving order information from a clinician and generating an order based thereon, the system comprising:
an order-entry subsystem operable to receive an order request from the clinician; and
a best-practice subsystem operable to determine a clinical context for the order and provide pre-determined practice information for enacting the order, based on the clinical context.

9. The system of claim 8, wherein the order-entry subsystem receives the order request in clinical shorthand.

10. The system of claim 8, wherein the best-practice subsystem is further operable to receive input from the clinician for selecting order characteristics from the practice information.

11. The system of claim 10, wherein the best-practice subsystem further comprises:
a decision support subsystem operable to provide links to relevant data that assists the clinician in selecting the order characteristics.

12. The system of claim 11, wherein the relevant data is patient-specific data.

13. The system of claim 11, wherein the relevant data presents current research findings.

14. An article of manufacture, which comprises a computer readable medium having stored therein a computer program carrying out a method for generating medical orders, the computer program comprising:
a first code segment for presenting high-probability action choices to a clinician based on an order request entered by the clinician;
a second code segment for presenting high-probability clinical context choices to the clinician based on an action chosen by the clinician;
a third code segment for presenting practice methods based on a clinical context chosen by the clinician; and
a fourth code segment for generating the medical order based on a practice method chosen by the clinician.

15. The article of manufacture of claim 14, wherein the first code segment receives the order request in clinical shorthand and the fourth code segment generates a natural-language version of the medical order.

16. The article of manufacture of claim 14, wherein the third code segment further presents decision-support data for assisting the clinician in choosing from among the practice methods presented.

17. The article of manufacture of claim 16, wherein the decision support data includes patient-specific data.

18. The article of manufacture of claim 16, wherein the decision support data includes current medical information.

19. The article of manufacture of claim 16, wherein the third code segment presents the decision support data by providing links to thereto during presentation of the practice methods.

20. The article of manufacture of claim 14, wherein the decision support data includes administratively-defined prerogatives.
